(19) United States
(12) Patent Application Publication
(10) Pub. No.: US 2022/0274034 A1
(43) Pub. Date: Sep. 1, 2022

(54) WATER TREATMENT CARTRIDGE

(71) Applicant: STRAUSS WATER LTD, Or Yehuda (IL)

(72) Inventors: Haim WILDER, Ra'anana (IL); Liron ALMISHALI, Petach Tikva (IL); Haya SANDORI-KAZAZ, Gedera (IL); Evgenia (Jeny) Liel KUKS, Ramat Gan (IL)

(73) Assignee: STRAUSS WATER LTD, Or Yehuda (IL)

(21) Appl. No.: 17/632,125

(22) PCT Filed: Jul. 30, 2020
(86) PCT No.: PCT/IL2020/050843

§ 371 Date: Feb. 1, 2022

Related U.S. Application Data
(60) Provisional application No. 62/881,667, filed on Aug. 1, 2019.

(30) Foreign Application Priority Data
Aug. 1, 2019 (CN) 201921241537.1

(51) Int. Cl. B01D 24/18; C02F 1/00; C02F 1/28; C02F 1/68; C02F 1/50; C02F 1/44

(52) U.S. Cl. CPC B01D 24/183; C02F 1/003; C02F 1/28; C02F 1/68; C02F 1/50; C02F 1/44; C02F 2303/04; C02F 2201/006; C02F 2307/04; C02F 2307/10; C02F 2301/02

(57) ABSTRACT

Provided are water treatment cartridges, in particular gravitational flow treatment cartridges, that include a flow restriction element.

### TECHNOLOGICAL FIELD

The present disclosure concerns water treatment cartridges, in particular gravitational flow treatment cartridges.

### BACKGROUND

Water treatment and/or filtering devices are typically utilized for treating source water (e.g. running water, well-water, river or lake water, etc.) into potable, drinkable water. Such devices typically contain various water filtering and/or treating media, through which the source water is passed, such that various contaminants are removed from the source water to obtain potable water.

In water supply systems that are based on pressurized water feeds, the water is forced through the filtering/treating device, and hence outflow of the potable water from the device is typically unhindered, as long as sufficient water pressure is maintained. However, when the source water feed is not pressurized, a gravitational-based device needs to be used. Such devices have typically an upper inlet and a bottom outlet, such that the water flow between the inlet and the outlet (through the treatment media) is carried out gravitationally.

One of the common problems of various gravitational-filtering devices is the initialization stage of utilizing the device; namely, as the media within the device is typically a porous, dry (before water is introduced) medium—once water is introduced therein, the initial flow of water into the device is hindered by air bubbles existing within the filtering/treatment medium. This, in turn, causes slow and uneven outflow of water from the device until all of the filtering/treatment media is soaked with water and no more air resides in the device.

### GENERAL DESCRIPTION

The present disclosure provides water treatment cartridges having a structure that minimizes the time required for initiation of the cartridge and provide a steady outflow of potable/treated water. Although the cartridge is designed to be used in gravitational filtering, it is appreciated that the cartridge can also be used in systems based on pressurized water feed.

In one of its aspects, the present disclosure provides a water treatment cartridge that comprises a housing, defining therein a water treatment space and having a longitudinal axis. The housing comprises one or more water inlets at a top portion of the housing and a water outlet at a bottom wall of the housing, the one or more water inlets and the water outlet defining a water flow path therebetween. An internal wall circumferring the water outlet extends upwardly from the bottom wall of the housing into the water treatment space to define a lumen. The internal wall terminates at an apex, the apex being at a lower level than the one or more water inlets to permit water flow from the inlet to the outlet through the treatment space. The cartridge further comprises a flow restriction element that is fitted at a bottom portion of the lumen, and having a water ingress substantially corresponding in dimensions to the bottom portion of the lumen, and a water egress having dimensions substantially smaller than the water ingress.

At the initial feed of source water into the cartridge, water will flow through the inlet(s) into the treatment media and partially wet it. Potable/treated water will then trickle into the lumen. Due to the narrowing of the outlet formed by the difference in dimensions between the ingress and the egress of the flow restriction element, treated water will accumulate within the lumen; once a sufficient water column is formed, a steady stream of treated water will flow out of the cartridge as long as the height of the water column within the lumen is maintained. Thus, the flow restriction element enables obtaining a steady flow of treated water out of the cartridge already at the initial stages of usage (i.e. at the “initiation” of the cartridge). Once all of the treatment media is saturated with water and a constant water column is obtained within the lumen, the flow restriction element enables obtaining a smooth uninterrupted outflow of treated water from the cartridge.

The term treated water (or potable water) is meant to denote water which have been treated by passing through one or more treatment media, that removes or adds various components from/to the water.

It should be noted that the terms top, bottom, horizontal and any other directional-based designations used herein are given for convenience only for the providing a frame of reference to describe relative position and orientation of the cartridge's components. During gravitational treatment of water, the “top” will face upwards, the “bottom” downwards. However, in other modes of use and/or other embodiments, the orientation may be different, e.g. in the case of a cartridge used in pressurized-water systems.

The term dimensions typically refers to the diameter of the outlet, ingress and/or egress when the cross section of these is circular. For other geometries, e.g. oval, polygonal, etc., the term is meant to refer to the largest dimension (an equivalent diameter). In some embodiments, each of the outlet, ingress and egress have a circular cross-sectional shape.

As noted, the dimensions of the egress are substantially smaller than the dimensions of the ingress in order to form said water column within the lumen. Thus, in some embodiments, the egress has a diameter that is at least 10%, at least 20%, at least 25%, at least 30%, at least 40% or even at least 50% smaller than the diameter of the ingress.

By some embodiments, the flow restriction element has a conical or frustoconical cross-sectional shape, i.e. having an inwardly-slanted wall linking the ingress and the egress.

In some embodiments, the flow restriction element is mechanically fitted into the bottom portion of the lumen. Such mechanical fitting may be by any means known in the art, e.g. screw-fitting, snap fitting, welding, adhering, etc. In a particular embodiment, the flow restriction element is snap-fitted into the bottom portion of the lumen.

In other embodiments, the flow restriction element may be an integral part of the housing, i.e. is integrally formed with the internal wall (and/or with the bottom wall).

The one or more water inlets may, by an embodiment, be located at a periphery of the top portion of the housing and the water outlet is located substantially at the center of the bottom wall. The one or more water inlets and the water outlet are configured such that the water flows in a generally lateral direction through the treatment space, e.g. in a generally radial direction from the one or more inlets at a top peripheral portion of the housing to a bottom outlet at about the center of a bottom portion of the housing. The term generally lateral direction means to denote the fact the flow has typically a curvilinear flow path and, by virtue of the fact that it is gravitational, has typically also a general downward trend and generally horizontal trend that is more pronounced than the vertical one. As the apex of the internal wall is at a level below the water inlet(s), a generally descending flow path will be formed from the inlet(s) to the outlet. Thus, according to an embodiment of this disclosure, the water flows through the cartridge from the peripheral inlets in a generally radial, overall descending (curvilinear) flow path to the cartridge's central outlet.

The water inlets are typically arranged such that the water flows generally uniformly throughout the entire treatment space of the cartridge, such that at least the majority (at time the entire) treatment media participates in the treatment process. In an embodiment, the water inlets may be arranged so as to have a uniform circumferential distribution in the cartridge's periphery. For example, the water inlets may be constituted by a plurality of apertures equidistantly distributed along the periphery of the housing's top wall; e.g. may consist of a number (e.g. 2, 3, 4, 5, 6, 8 or more) of openings.

In some embodiments, the treatment space is divided into two or more treatment chambers, typically, albeit not exclusively, by one or more closed-loop walls downwardly extending into the treatment space from a top wall of the housing and positioned between an external wall of the housing and said internal wall to divide the treatment space into at least a first treatment chamber and a second treatment chamber. The closed-loop wall(s) typically terminates in a bottom edge that is spaced-apart from the bottom wall of the housing to form a water passage between the first and the second treatment chambers, the closed-loop wall and the internal wall jointly cause the water to flow in a curvilinear flow path from the water inlet to the water outlet.

The closed-loop wall, together with the internal wall, serve as barriers that do not permit the water to flow in a linear path within the treatment space, but rather assume a curvilinear flow path. Such a curvilinear flow path extends (elongates) the residence time of the water within the treatment space by effectively increasing the length of the flow path, thus increasing the exposure of the source water to the treatment media. In some embodiments, the closed-loop wall and the internal wall are concentric, typically coaxial and essentially parallel to the cartridge's longitudinal axis.

By an embodiment, at least one of the first and second treatment chambers can comprise, independently, one or more horizontal divider elements for dividing the treatment chambers into treatment compartments. Such horizontal divider elements are typically perforated or formed out of a mesh, thus permitting flow of water therethrough.

The cartridge described herein is typically designed for the purpose of purifying water, in particular to obtain treated/potable water from source water. According to some embodiments, the treatment space comprises one or more water treatment media. By some exemplary embodiments, each of the treatment chambers (and/or each of the treatment compartments) can comprise same or different treatment media.

In accordance with some embodiments, the treatment medium may comprise components that release a beneficial substance to the water during treatment. Such a substance may be of a nutritional or health value or may have a water disinfecting activity. A specific example of such a substance comprises a halogen (e.g. iodine) or a mineral (e.g. magnesium ions).

By an embodiment, the treatment space can comprise a porous substrate, for examples in the form of a mesh net, granulated or flaked loose material, a porous block, fibers, etc. In another embodiment, the treatment media can comprise a sorbing substrate for sorbing substance(s) from the water. In some other embodiments, the treatment media may be one or more hollow-fiber membrane, e.g. for removal of microbiological contaminants and/or microplastics.

Examples of water treatment medium may be charcoal, activated carbon, ion exchangers (anionic, cationic, mixed bed, etc.), scaling reduction substances, ion/mineral sources (e.g. natural rock salts or synthetic sources), microplastics reducing media, antimicrobial media, etc.

The cartridge may further comprise one or more supplementary treating units, fitted about the egress of the flow restriction element. The supplementary treating unit may be in the form of a container, that is configured for attaching to the egress of the flow restriction element, either permanently or removably. The supplementary treating unit may, by some embodiments, be integrally formed with the flow restriction unit.

In order to permit substantially uniform flow of water existing the cartridge from the narrow egress of the flow restriction unit, the supplementary treating unit may have an inlet that is configured with a flow diffuser, designed to substantially evenly distribute the water flow through the supplementary treating unit.

The supplementary treating unit may comprise one or more water treating media, different or the same as those within the treatment chambers of the cartridge. By an embodiment, the supplementary treating unit comprises one or more hollow-fiber membrane, that is configured for physical removal of various contaminants from the water, typically microorganisms and microplastics. The hollow-fiber membrane may have, for example, a pore size of at least 0.01 μm (micrometers), typically between about 0.01 μm and 0.5 μm. The hollow-fiber membrane may be any suitable hollow-fiber membrane known in the art. Non-limiting examples of suitable hollow-fiber membranes may be various polymeric-based hollow-fibers (e.g. polyethylene, polypropylene, polystyrene, Polyvinylidene fluoride (PVDF), polyamide, polymethylmethacrylate (PMMA), acrylonitrile and sodium methallylsulfonate copolymers (e.g. AN69), polyacrylonitrile-polyvinylchloride copolymers, etc.). The hollow-fibers may be arranged in any suitable form within the supplementary treating unit, for example, parallel to the longitudinal axis of the cartridge, folded or weaved.

According to some embodiments, the cartridge may comprise one or more vent openings configured to release gas (e.g. air) that is entrapped within the cartridge. Such vent openings can be typically formed at a top portion of the cartridge. The vent openings may be fluidically linked to the lumen by a venting duct, thus permitting release of gas bubbles that may be entrapped within the lumen that may hinder water outflow from the cartridge. In other embodiments, the cartridge may comprise at least one bubble release mechanism, which may be passive or active (i.e. may be operated without involvement of the user or requires an action of the user for activation).

As noted above, the flow restriction element can be an integral part of the inner wall (or the bottom wall of the housing). Alternatively, the flow restriction element can be a stand-alone unit, that can be attached or fitted into the lumen (or over the cartridge's outlet). Thus, in another aspect of this disclosure, there is provided a flow restriction unit having a longitudinal axis and configured for fitting into a water outlet of a water treatment cartridge, the flow restriction unit comprising a top opening and a bottom opening defining therebetween a flow path, the dimensions of the bottom opening being smaller from the dimensions of the top opening.

In another aspect, the present disclosure provides a water container that comprises a bottom treated/potable water reservoir with a dispensing outlet; a top source water reservoir; an internal wall separating between the source water reservoir and the treated/potable water reservoir and comprising a cartridge-receiving seat; and a cartridge as defined herein, received in said cartridge-receiving seat, such that the water outlet of the cartridge opens into the potable water reservoir and the one or more water inlets open into the source water reservoir.

The container can be any type of container known per se, e.g. a water pitcher.

By another aspect there is provided method for gravitationally treating source water into treated/potable water, the method comprising placing a cartridge as described herein into the cartridge-receiving seat of the container described herein; at least partially filling the source water reservoir with source water; and permitting the source water to gravitationally flow through the cartridge into the potable water reservoir.

By another aspect, there is provided a water dispenser comprising a cartridge as disclosed herein.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1B are perspective top and bottom views, respectively, of a water treatment cartridge according to an embodiment of this disclosure.

FIG. 2A is a longitudinal cross section through a water treatment cartridge according to an embodiment of this disclosure.

FIG. 2B is a longitudinal cross section through a water treatment cartridge according to another embodiment of this disclosure, including one or more treatment media.

FIG. 3 is a longitudinal cross section of the flow restriction element according to an embodiment of this disclosure.

FIG. 4A-4C are longitudinal cross sections through water treatment cartridges according to other embodiments of this disclosure.

FIG. 5A is a longitudinal cross section through a water treatment cartridge according to another embodiment of this disclosure that includes a hollow-fiber membrane supplementary unit.

FIG. 5B is a longitudinal cross section through a water treatment cartridge according to another embodiment of this disclosure that includes another configuration of a hollow-fiber membrane supplementary unit.

### DETAILED DESCRIPTION OF EMBODIMENTS

In the following description, specific embodiments of a cartridge according to the present disclosure will be described. It should be appreciated that the invention is not limited to these embodiments.

The cartridge exemplified herein may be used in gravitational water treating systems (e.g. water pitchers) or in pressure-feed water treating systems (e.g. water dispensers).

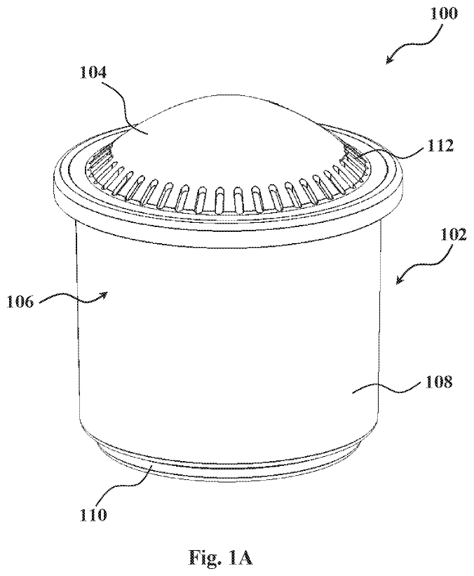

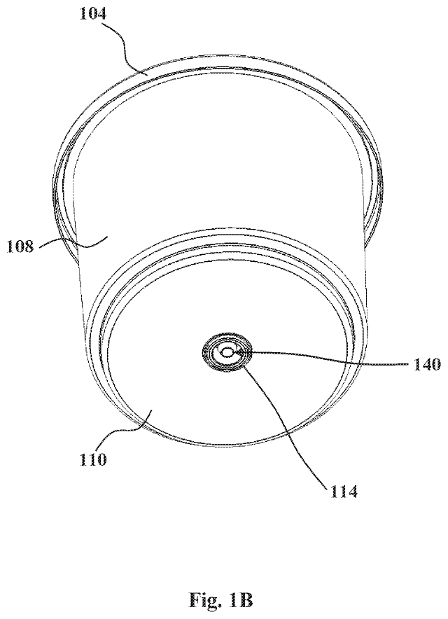

Reference is first being made to FIGS. 1A-1B showing a water treatment device generally designated 100 including a housing 102 formed by a cover 104 constituting a top wall of the cartridge, and a cup-shaped body 106 fitted thereto. The cup-shaped body can be fitted with the cover by any means known per-se, e.g. a snap-type arrangement, a screw-fit arrangement, welding, etc. Cup-shaped body comprises an external wall 108 and a bottom wall 110, constituting the bottom wall of the housing. Defined in the cover 104 are water inlets 112, which in this specific example are located at a periphery of the top portion of the housing, and are substantially symmetrically distributed in the top wall of the housing to provide for uniform inflow of source water. As can be better seen in FIG. 1B, a water outlet 114 is located substantially at the center of the bottom wall 110.

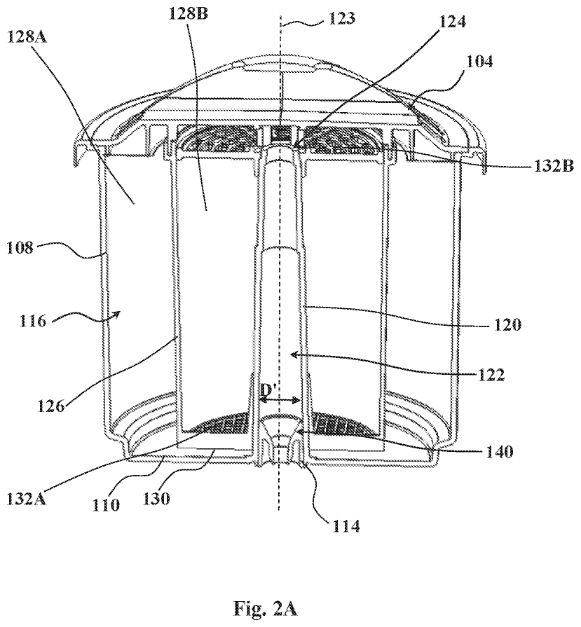

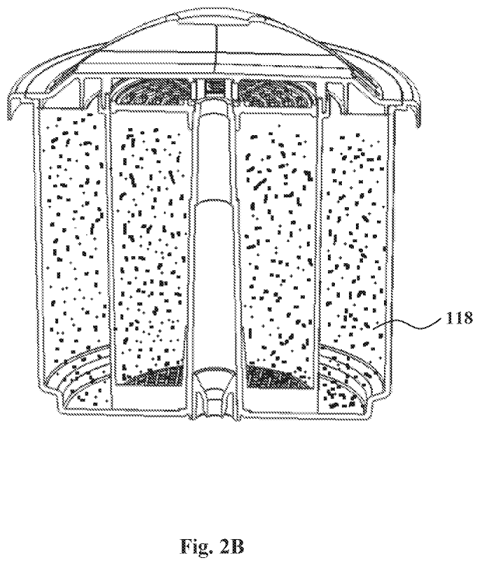

A longitudinal cross-sectional view of the cartridge is shown in FIGS. 2A-2B, in which internal elements of the cartridge can be seen. The internal space 116 of the cartridge is typically filled with one or more treatment media 118 (as seen in FIG. 2B). In case particulate treatment media is utilized, cover 104 may be provided at an inward-facing surface thereof with a filtering mesh (not shown), preventing the particulate filtering media from migrating between treatment compartments due to flow of water therethrough. Internal wall 120 extends upwardly from bottom wall 110 into the water treatment space, and defines a lumen 122. The internal wall 120 circumferences the water outlet 114, such that the lumen extends along the longitudinal axis 123 of the cartridge. The internal wall 120 terminates at an apex 124 that is located at a lower level than water inlets 112.

In the exemplified embodiment, the cartridge further comprises a closed-loop wall 126 that extends downwardly into the treatment space from a top wall 112, and positioned between an external wall 108 of the housing and internal wall 120. Wall 126 divides the treatment space into concentric first treatment chamber 128A and second treatment chamber 128B, each can comprise the same or different treatment media. The closed-loop wall 126 terminates in a bottom edge 130 that is spaced-apart from the bottom wall 110 of the housing to form a water passage between the first and the second treatment chambers, such that a curvilinear flow path from the water inlet to the water outlet is formed. The top and bottom of second treatment chamber 128B may comprise, although not mandatory, bottom mesh element 132A and top mesh element 132B to hold the treatment media in place within chamber 128B, and prevent its drifting into lumen 122 during flow of water through the cartridge.

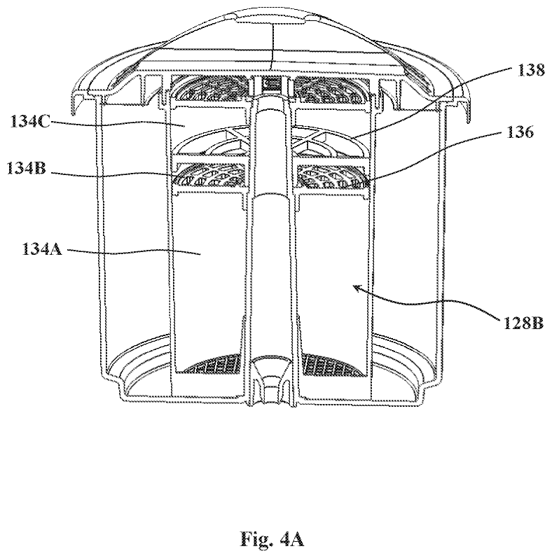

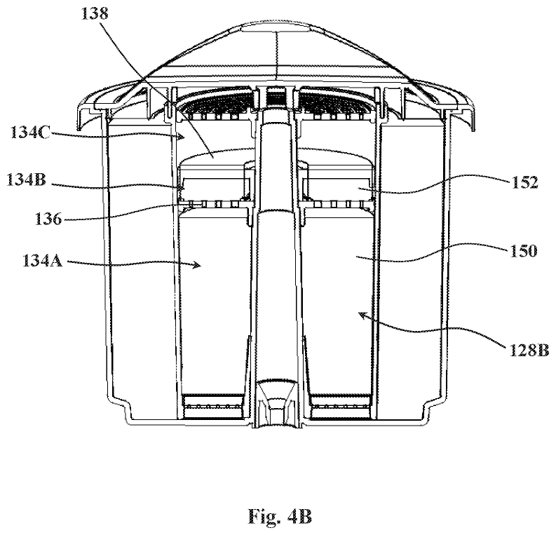

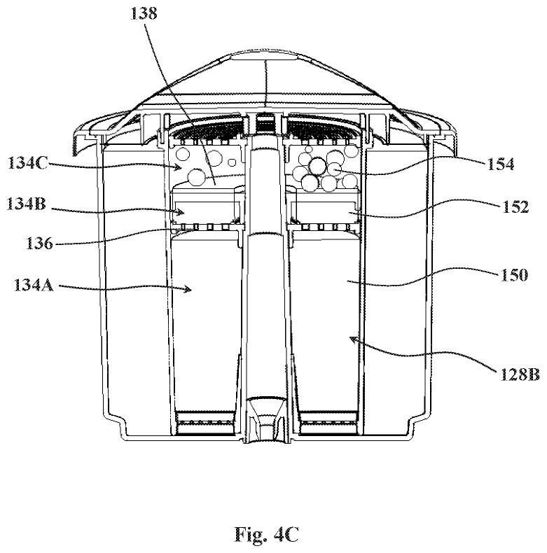

In the embodiment shown in FIGS. 4A-4C, the second chamber 128B is further divided into treatment compartments 134A, 134B and 134C by horizontal dividers 136 and 138. The compartments may comprise the same or different treatment media, as required by the water treatment requirements, depending on the contaminants in the source water or the quality of potable water to be obtained by the treatment. For example, in the configuration of FIG. 4B, treatment compartments 134A and 134B may comprise different filtering/treating media 150 and 152, respectively; while in the configuration of FIG. 4C, each of treatment compartments 134A-134C comprises different filtering/treating media (150, 152 and 154, respectively). As seen, the treatment medium in each compartment may be of various forms. e.g. a solid block, porous material, fibrous material, particulate matter, etc.

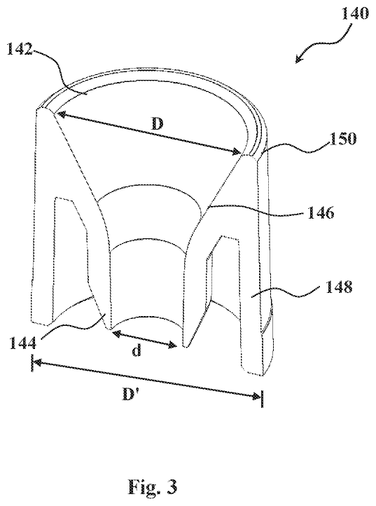

Turning back to FIGS. 1A-3, the cartridge comprises a flow restriction element 140 (seen in isolation in FIG. 3) fitted at a bottom portion of lumen 122. The flow restriction element 140 comprises a water ingress 142 with a diameter D (that substantially corresponds to the diameter D′ of the bottom portion of the lumen), and a water egress 144 having a diameter d substantially smaller than that of the water ingress. As noted, at the initial feed of source water into the cartridge, water will flow through the inlets 112 into the treatment space and partially wet the treatment media. Treated water will then trickle into the lumen 122. Due to the narrowing of the outlet 114 formed by the difference in diameters between the ingress 142 and the egress 144, treated water will be accumulated within the lumen; once a sufficient water column is formed, a steady stream of treated water will then flow out of the cartridge as long as the height of the water column within the lumen is maintained.

The flow restriction element 140 is has a typical conical or frustoconical cross-sectional shape, with an inwardly-slanted wall 146 linking between the ingress (top opening) 142 and the egress (bottom opening) 144. In order to ensure tight fitting of the flow restriction element 140 within the bottom portion of lumen 120, element 140 comprises a circumferential skirt 148 extending downwardly from top rim 150, enveloping the inwardly-slated wall 146, such that the overall diameter of the flow restriction element is D′, thus ensuring tight fit within lumen 122.

As noted, the flow restriction element 140 can be a stand-alone unit, that can be fitted into the lumen by any means known per-se (as shown in FIG. 2A). However, it is also to be understood that the flow restriction element can be an integral part of the housing, e.g. integrally formed with the internal wall 120 or the bottom wall 110 (not shown).

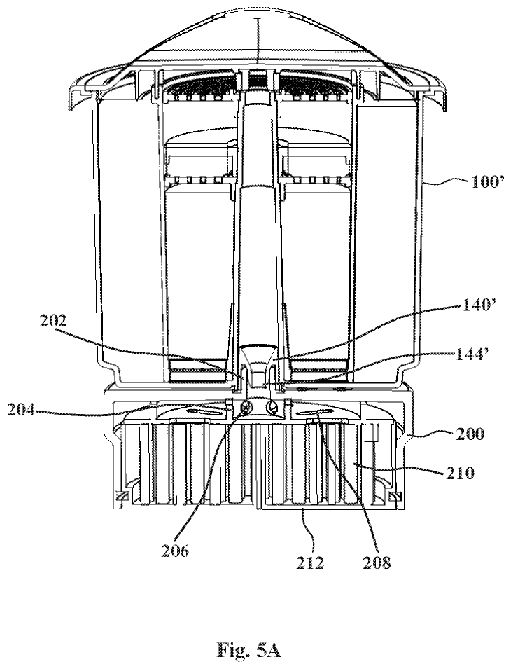

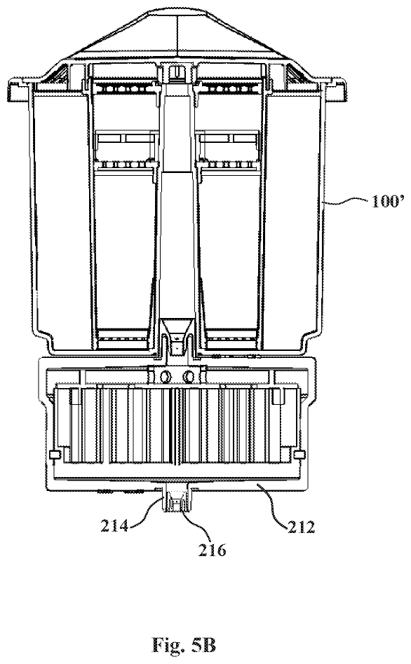

The cartridge may further comprise a supplementary treating unit for providing further water treatment functionalities, as seen in FIGS. 5A-5B. Cartridge 100′ in FIGS. 5A-5B has the same structural elements as those of the cartridges of FIGS. 1A-4C, and the reader is referred to the description of these figures hereinabove for full details.

Cartridge 100′ in FIG. 5A is fitted with supplementary treating unit 200. The supplementary treating unit 200 comprises a unit inlet 202, tightly fitted about egress 144′ of the flow restriction unit 140′, such that water flowing out of the egress 144′ enters the supplementary treating unit 200. Flow diffuser 204 is located below the inlet 202 and comprises openings 206—flow diffuser 204 functions to direct and diffuse the flow of water received from cartridge 100′, such that the flow of water is substantially evenly distributed along the entire cross section of unit 200, to trickle into hollow-fiber membrane 210 through orifices 208. Water is physically treated (e.g. filtered) through the hollow-fiber membrane 210 and exit supplementary treating unit 200 through perforations (not shown) formed in the bottom wall 212 of the unit 200.

In the configuration of FIG. 5B, the bottom wall 212 of unit 200 includes a central unit outlet 214 (instead of perforations). The unit outlet 214 may be fitted, in this specific example, with a flow restricting unit 216 (which may or may not have a similar structure to that of flow restricting unit 140).

The cartridge can be utilized in various configurations, either for gravitational based systems or for pressure-feed systems. One example of a gravitational system is a water container or a water pitcher (not shown), which can include an internal wall separating between a source water reservoir and a potable water reservoir. The internal wall can have a cartridge-receiving seat for receiving and holding the cartridge in place, such that the water outlet of the cartridge opens into the potable water reservoir and the one or more water inlets open into the source water reservoir. Thus, source water filled by a user into the source water reservoir enters the cartridge, treated therein to obtain treated/potable water, and is dispensed through the flow restricting element of the cartridge into the treated/potable water reservoir, from which it can be dispensed through the dispensing outlet.

1. A water treatment cartridge, comprising:
a housing, defining therein a water treatment space and having a longitudinal axis, the housing comprising one or more water inlets at a top portion of the housing and a water outlet at a bottom wall of the housing, the one or more water inlets and the water outlet defining a water flow path therebetween;
an internal wall circumferring the water outlet and extending upwardly from said bottom wall into the water treatment space to define a lumen, the internal wall terminating at an apex, the apex being at a lower level than the one or more water inlets; and
a flow restriction element fitted at a bottom portion of said lumen, and having a water ingress substantially corresponding in dimensions to the bottom portion of the lumen, and a water egress having dimensions substantially smaller than the water ingress.

2. The cartridge of claim 1, wherein said flow restriction element has a conical or frustoconical cross-sectional shape.

3. The cartridge of claim 1, wherein the flow restriction element is snap-fitted into the bottom portion of the lumen.

4. The cartridge of claim 1, wherein the flow restriction element is integrally formed with the internal wall.

5. The cartridge of claim 1, wherein said one or more water inlets are located at a periphery of the top portion of the housing and the water outlet is located substantially at the center of the bottom wall.

6. The cartridge of claim 5, wherein said one or more water inlets are constituted by one or more apertures at the top wall of the housing.

7. The cartridge of claim 5, wherein said one or more water inlets are symmetrically distributed in the top wall of the housing to provide for uniform inlet flow.

8. The cartridge of claim 1, configured for treating source water into potable water.

9. The cartridge of claim 1, wherein the treatment space is divided into two or more treatment chambers.

10. The cartridge of claim 9, comprising a closed-loop wall downwardly extending into the treatment space from a top wall of the housing and positioned between an external wall of the housing and said internal wall to divide the treatment space into a first treatment chamber and a second treatment chamber.

11. The cartridge of claim 10, wherein the closed-loop wall terminates in a bottom edge that is spaced-apart from the bottom wall of the housing to form a water passage between the first and the second treatment chambers, the closed-loop wall and the internal wall jointly cause the water to flow in a curvilinear flow path from the water inlet to the water outlet.

12. The cartridge of claim 9, wherein each of the treatment chambers comprises a different treatment medium.

13. The cartridge of claim 9, wherein at least one of the first and second treatment chambers comprises, independently, one or more horizontal divider elements for dividing the treatment chambers into treatment compartments.

14. The cartridge of claim 1, wherein the treatment space comprises one or more water treatment media one or more sorbing substances, one or more substances having a nutritional or health value or having a water-disinfecting activity, and/or one or more hollow-fiber membranes.

15.-17. (canceled)

18. The cartridge of claim 1, comprising a supplementary treating unit, fitted about the water egress of the flow restriction element.

19. The cartridge of claim 18, wherein the supplementary treating unit is removably fitted about the water egress of the flow restriction element.

20. The cartridge of claim 18, wherein the supplementary treating unit is integral with flow restriction element.

21. The cartridge of claim 18, wherein the supplementary treating unit comprises one or more hollow-fiber water membrane.

22.-24. (canceled)

25. A water container, comprising:
a bottom potable water reservoir with a dispensing outlet;
a top source water reservoir;
an internal wall separating between the source water reservoir and the potable water reservoir and comprising a cartridge-receiving seat; and
a cartridge according to claim 1 received in said cartridge-receiving seat, such that the water outlet of the cartridge opens into the potable water reservoir and the one or more water inlets open into the source water reservoir.

26. (canceled)

27. A water dispenser comprising a cartridge according to claim 1.
